(19) United States
(12) Patent Application Publication
(10) Pub. No.: US 2025/0002718 A1
(43) Pub. Date: Jan. 2, 2025

(54) FOAMED ARTICLE AND METHOD FOR PREPARING THE SAME

(71) Applicant: Evonik Operations GmbH, Essen (DE)

(72) Inventors: Chenyu Ye, Shanghai (CN); Kathrin Salwiczek, Recklinghausen (DE); Dominik Vogel, Duesseldorf (DE); Beiyuan Zhu, Shanghai (CN); Michael Gerhard Hagemann, Kahl am Main (DE); Urs Welz-Biermann, Allentown, PA (US)

(73) Assignee: Evonik Operations GmbH, Essen (DE)

(21) Appl. No.: 18/709,975

(22) PCT Filed: Nov. 2, 2022
(86) PCT No.: PCT/CN2022/129238

§ 371 Date: May 14, 2024

(30) Foreign Application Priority Data
Nov. 15, 2021 (WO) PCT/CN2021/130635

(51) Int. Cl. C08L 77/02; C08J 9/00; C08J 9/12

(52) U.S. Cl. CPC C08L 77/02; C08J 9/0061; C08J 9/122; C08J 2203/08; C08J 2205/044; C08J 2207/00; C08J 2377/02; C08J 2475/08; C08L 2203/14; C08L 2203/30

(57) ABSTRACT

A foamed article is synthesized from a blend of homogenously mixed polyether amide and thermoplastic polyurethane. A method for preparing the foamed article includes providing a polyether block amide and a thermoplastic polyurethane, compounding the polyether block amide and the thermoplastic polyurethane and forming a blend, shaping the blend and forming a preform, and foaming the preform and obtaining the foamed article.

### FIELD OF THE PRESENT DISCLOSURE

The present disclosure relates to a foamed article and to a method for preparing the same.

### BACKGROUND

Flexible polymeric foams were widely applied in sport shoe sole assembly to decrease weight and provide sufficient flexibility. Traditionally, the plastic flexible foams were generated via chemical reaction by chemical blowing agents, which are usually hazard substances and/or cause unfriendly odors. Recent years, usage of supercritical state gas as blowing agents has been introduced into sport shoe sole manufacture. In that technology, supercritical state gas, e.g., N2, CO2, acts as physical blowing agent. Furthermore, foamed thermoplastics have been prepared by some advanced supercritical state gas foaming technologies where cross-linkers are not necessary, which makes production not only more environment friendly but also more economic since the thermoplastic foam can be recycled.

Such technology has been applied on various thermoplastic elastomers, e.g., polyether blocked amide (PEBA), thermoplastic polyurethane (TPU), ethylene-vinyl acetate (EVA), to make flexible foams for shoe soles. Among foams made of the above-mentioned elastomers, PEBA and TPU foams show their distinguished performance. PEBA foam provides very low density, high hardness, and excellent resilience, which make it a candidate for running shoe soles. However, tear strength of PEBA foams is unsatisfied. Compared to PEBA foams, TPU foams show higher density, lower hardness, and lower resilience. However, they often have a good tear strength. A combination of the desired performances from both PEBA and TPU foams is expected.

A high-quality requires uniformly distributed and stable microcellular structures, which is difficult to be achieved by blending PEBA and TPU due to the insufficient compatibility between the two. Phase separation between PEBA and TPU will be caused/aggravated after foaming. It was observed that the blend developed laminated structures which brought undesired performance to the PEBA-TPU blend foam. Compatibility of PEBA and TPU can be improved by introducing compatibility aids into the blend system, but generally such additives can alter the color, hardness and/or density of the foam.

In CN108250734B mixtures of TPU and a block polyether amide elastomer product are described. The used kind of elastomer PABAX is unknown. The resulted foams have densities of 0.176 g/m3 or more.

EP3640287A1 describes mixtures of amino-regulated polyether block amides and acrylates for preparing foams.

### SUMMARY OF THE PRESENT DISCLOSURE

It is one objective of the present disclosure to provide a foamed article made from homogenously mixed polyether block amide-thermoplastic polyurethane blend, which can maintain desired performances including high mechanical hardness, low density, and good resilience.

Such objective is achieved by a foamed article prepared by a process comprising, providing a polyether block amide and a thermoplastic polyurethane; compounding the polyether block amide and the thermoplastic polyurethane and forming a blend; shaping the blend and forming a preform; and foaming the preform and obtaining a foamed article.

Hereinafter, the term “compounding” means mixing of components in a molten state to form a homogenous blend. By this definition, dry blending, that is to say, mixing components in solid phase (usually in form of pellets), is not compounding.

According to the invention, wherein the thermoplastic polyurethane has a weight percentage of less than 22 wt. % in the blend, preferably less than 20 wt. %, more preferably less than 18 wt. %.

According to some embodiments, the foamed article has a microcellular structure with an average diameter of 40 μm to 400 μm. The diameter is measured by scanning electron microscopy (SEM). According to some embodiments, the microcellular structure has a wall with a thickness of 1 μm to 20 μm. The thickness is measured by scanning electron microscopy (SEM).

According to some embodiments, the foamed article has a density lower than 0.12 g/cm3, preferably a density lower than 0.1 g/cm3, more preferably a density lower than 0.09 g/cm3.

According to some embodiments, wherein the blend is essentially free of compatibilizers or compounding aids.

According to some embodiments, the foamed article is selected from the group consisting of articles of clothing, footwear, protective equipment, straps, and components thereof.

According to some embodiments, the foamed article is a shoe sole.

Another perspective of the present disclosure is to provide a method for preparing a foamed article comprising, providing a polyether block amide and a thermoplastic polyurethane; compounding the polyether block amide and the thermoplastic polyurethane and forming a blend; shaping the blend and forming a preform; foaming the preform; and obtaining a foamed article.

According to some embodiments, the step of compounding the polyether block amide and the thermoplastic polyurethane is conducted by using a twin-screw extruder.

According to some embodiments, the step of foaming the blend comprises soaking the preform in a supercritical gas.

According to some embodiments, the supercritical gas is one or more selected from supercritical nitrogen, supercritical carbon dioxide, and a mixture thereof.

According to some embodiments, the step of foaming the blend is under a temperature lower than a melting temperature of the blend.

According to some embodiments, the supercritical gas is under a temperature of 20° C. to 300° C., preferably 60° C. to 250° C., more preferably 80° C. to 200° C.

According to some embodiments, the supercritical gas is under a pressure of 20 bar to 500 bar, preferably 60 bar to 400 bar, more preferably 100 bar to 400 bar.

According to some embodiments, the step of foaming the blend is carried out in an autoclave.

### BRIEF DESCRIPTION OF THE DRAWINGS

FIG. 1 shows a photograph of a foamed article prepared from compounded PEBA-TPU composition.

FIGS. 2 and 3 show photographs of a foamed article prepared from dry-blended PEBA-TPU composition in two different directions.

FIGS. 4 and 6 show a scan electron microscopy diagram of the foamed article depicted in FIG. 1.

FIGS. 5 and 7 show a scan electron microscopy diagram of the foamed article depicted in FIGS. 2 and 3.

### DETAILED DESCRIPTION

Polyether block amides (PEBA) are block copolymers which are obtained by polycondensation of (oligo)polyamides, in particular acid-regulated polyamides, with alcohol-terminated or amino-terminated polyethers. Acid-regulated polyamides have carboxylic acid end groups in excess. Those skilled in the art refer to the polyamide blocks as hard blocks and the polyether blocks as soft blocks. The production thereof is known in principle. DE2712987A1 (U.S. Pat. No. 4,207,410) describes polyamide elastomers of this type, composed of lactams containing 10-12 carbon atoms, dicarboxylic acids and polyether diols. The products obtainable according to this document are distinguished by long-lasting flexibility and ductility even at low temperatures, but they are already cloudy to opaque in moldings of moderate layer thickness and, on longer-term storage at room temperature, are conspicuous due to surface deposits having a mildew-like appearance. Similarly structured polyamide elastomers, assembled from diamines containing 6-20 carbon atoms, aliphatic or aromatic dicarboxylic acids and polyether diols, are known from EP0095893. Distinctive properties are increased heat distortion resistance and flexibility. No data regarding translucency of the moldings and formation of deposits can be gathered from this document.

Polyether block amide and thermoplastic polyurethane are compounded to form a blend. The compounding method can involve a mixer with a strong shear. Preferred mixers include a twin-screw extruder.

After compounding, the polymeric blend is subject to shaping and then a preform is formed. The preform can be formed by any shaping method or process. Preferred are processes including compression-molding, extrusion molding, coextrusion molding, blow molding, 3D blow molding, coextrusion blow molding, coextrusion 3D blow molding, coextrusion suction blow molding, injection molding, stereolithography, digital light processing, continuous liquid interface production, fused filament fabrication, sheet lamination, selective laser melting, etc. More preferred are extrusion molding and injection molding.

The preform undergoes a foaming process and a foamed article is obtained.

Preferably, the step of foaming the blend comprises soaking the preform in a supercritical gas. Known supercritical gas includes supercritical nitrogen, supercritical carbon dioxide, or mixture thereof.

Foaming the preform can be preferably conducted under a temperature lower than a melting temperature of the blend to keep the blend from melting or softening, thereby maintaining the shape of preform. In some embodiments, foaming is under a temperature of 20° C. to 300° C., preferably 60° C. to 250° C., more preferably 80° C. to 200° C.

The foaming process is conducted in a pressurized atmosphere. Foaming is under a pressure of 20 bar to 500 bar, preferably 60 bar to 400 bar, more preferably 100 bar to 400 bar.

According to some embodiments, an autoclave is used to carried out the foaming process. The term “autoclave” refers to any device that is capable to carry out heating under an elevated pressure in relation to ambient pressure. In that sense, the autoclave may include a conventional autoclave, a high-pressure reactor, a foaming mold, etc.

### [Foams and Foamed Article]

The compounded PEBA-TPU composition can undergo a foaming process, in which a foaming agent, preferably a physical foaming agent, blows up the composition. In the end of the foaming process, a foamed article is formed. The foamed article can have a plurality of microcells distributed inside, which make the density of the foamed article very low, compared to that of the un-foamed composition. The foamed article also can express a multitude of mechanical properties that are desired in various applications, such as, a high compression set, a good ball rebound resilience, a high hardness Asker C value, etc. The compression set can be lower than 40%. The ball rebound resilience can be larger than 70%. The foamed article can have a hardness Asker C value of about 30 to 70 or preferably about 35 to 55.

The foamed article can find many applications in the form of articles of clothing, footwear, protective equipment, straps, and components thereof. Particularly preferably, the foamed article can be a shoe sole.

### [PEBA]

PEBAs used herein are preferably based on a subunit 1, composed of at least one lactam or α,ω-aminocarboxylic acid having 6 to 14 carbon atoms, and on a subunit 2, composed of at least one amino- or hydroxy-terminated polyether having at least 2 carbon atoms per ether oxygen and at least two primary amino or having at least two carbon atoms per ether oxygen and at least two hydroxy groups at chain ends.

PEBAs are known in the art and result from the polycondensation of polyamide blocks with reactive ends and polyether blocks with reactive ends. It is preferred to obtain PEBA from polyamide blocks with dicarboxylic chain ends. Subunit 1 can result from the condensation of one or more α,ω-aminocarboxylic acids or of one or more lactams in the presence of a dicarboxylic acid, preferably a linear aliphatic dicarboxylic acid. The dicarboxylic acid can contain from 4 to 36 carbon atoms, preferably from 6 to 12 carbon atoms. As examples of dicarboxylic acids mention can be made of 1,4-cyclohexyldicarboxylic acid, butanedioic, adipic, azelaic, suberic, sebacic, dodecanedicarboxylic, octadecanedicarboxylic and terephthalic and isophthalic acids, but also dimerized fatty acids. PEBA and methods for their production are described in US 2006/0189784, for example.

PEBA for the molding composition can be used as prepared or available from the market. Commercially, PEBAs with different subunit 1 as polyamide part or subunit 2 as polyether part can be purchased from, for example, Evonik Resource Efficiency GmbH and Arkema S.A.

### [Thermoplastic Polyurethane]

Thermoplastic polyurethanes used herein can be a variety of polyurethanes prepared from aliphatic or aromatic polyisocyanate, a polyol based on a polyether, polyester, or polycarbonate linkage, and sometimes a short chain diol (referred to as “chain extender”).

Aliphatic polyisocyanate for the thermoplastic polyurethane can be any aliphatic polyisocyanate. Exemplary aliphatic polyisocyanates include methylene bis(4-cyclohexylisocyanate) (HMDI), hexamethylene diisocyanate, and isophorone diisocyanate. Aromatic polyisocyanate can be polyisocyanate with at least two isocyanate groups connected to aromatic ring. Exemplary aromatic polyisocyanates include isomers of toluene diisocyanate (TDI), methylene di(phenylisocyanate) (MDI), and naphthalene diisocyanate.

Polyether polyol can be prepared by reacting alkylene oxide such as ethylene oxide or propylene oxide with diols such as ethylene glycol, propylene glycol, or butanediol. Exemplary polyether diols include polyethylene glycol, polypropylene glycol, poly(tetrahydrofuran) diol. Polyester polyol can be prepared by a condensation of dicarboxylic acid with excess diol, a reaction between diols and polyesters, e.g., polylactide, or a ring opening of lactone with diols. Exemplary polyester diols include poly(1,4-butylene adipate) diol, polylactide diol, and polycaprolactone diol. Polycarbonate polyol can be prepared by reacting an aliphatic carbonate and one or more diol. Exemplary polycarbonate diols include poly(propylene carbonate) diol, poly(hexamethylene carbonate) diol, or poly(polytetrahydrofuran carbonate) diol.

Thermoplastic polyurethanes can be commercially purchased from various manufacturers, for example, BASF SE, Lubrizol, and Covestro AG.

The present disclosure is illustrated by way of example and comparative example hereinbelow.

### EXAMPLES

The following materials were employed in the reference, the examples and the comparative examples:

Vestamid® E40-S3 from Evonik Operations GmbH is a low-density polyether block amide (PEBA) block polymer, containing segments of PA 12 and polyether. Vestamid® E40-S3 has a Shore D hardness of 40.

Vestamid® E55-S3 from Evonik Operations GmbH is a low-density polyether block amide (PEBA) block polymer, containing segments of PA 12 and polyether. Vestamid® E55-S3 has a Shore D hardness of 55.

Elastollan® 1180A from BASF Polyurethanes GmbH is a thermoplastic polyurethane based on methylene diphenyl diisocyanate, poly(tetrahydrofuran) with number average molecular weight (Mn) of about 1,000 g/mol, poly(tetrahydrofuran) with average Mn of about 2,000 g/mol, and butanediol. It has a Shore A hardness of 80.

Elastollan® 1195 A from BASF Polyurethanes GmbH is a thermoplastic polyurethane based on polyether. It has a Shore A hardness of 96.

Desmopan® DP 3695 AU from Covestro GmbH is a thermoplastic polyurethane based on a C4 ester. It has a Shore A hardness of 95.

Tensile modulus of elasticity, tensile stress at yield, and tensile stress at break were determined by Zwick Z020 materials testing system according to ISO 527, on ISO tensile specimens, type 1A, 170 mm×10 mm×4 mm at a temperature (23±2) ° C., relative humidity (50±10) %.

Notched impact strength was determined by CEAST Resil Impactor 6967.000, according to ISO 179/1eA (Charpy) on tensile specimens ISO 527 type 1A which were cut off two ends, 80 mm×10 mm×4 mm at a temperature (23±2) ° C., relative humidity (50±10) %.

Hardness (shore D) was determined by Time Group Shore D hardness tester TH210, according to ISO 868, on tensile specimens ISO 527 type 1A 170 mm×10 mm×4 mm at a temperature (23±2) ° C., relative humidity (50±10) %.

Hardness (Asker C) of foamed articles was determined by Asker Durometer Type C, according to JIS K 7312.

In accordance with ASTM D 3574, foam samples were placed in and compressed by a compression device to be deflected to 50% of its original thickness. The foam samples were then allowed to relax for 22 hours at 50° C. The original and final thicknesses were measured with a caliper. Compression set was calculated by dividing the difference in thickness with the original thickness.

Ball rebound resilience was determined with a ball rebound resilience tester by vertically dropping a steel ball on foam from a given height and measuring the rebound height in accordance with ASTM D 3574.

### Inventive Examples 11 to 13

17 kg of PEBA and 3 kg of TPU were mixed using a Coperion ZSK—26 cm co-rotating twin screw extruder, discharged, pelletized to obtain compounded PEBA-TPU pellets. The temperature was set to 220° C. and a screw rotation speed was set to 250 rounds per minute (RPM). The compounding was conducted with a throughput of 20 kg/h.

The compounded PEBA-TPU compositions in pellet form were processed on an injection molding machine Engel VC 650/200 (melt temperature 220° C., mold temperature 35° C.) to prepare shoe sole preforms for further foaming. Injection pressure and holding pressure were 400 bar and 600 bar, respectively.

### Comparative Example C1

17 kg of Vestamid® E40-S3 and 3 kg of Elastollan® 1180A were dry blended using a drum hoop mixer under room temperature. The dry-blended PEBA-TPU compositions in pellet form were processed on an injection molding machine Engel VC 650/200 (melt temperature 220° C., mold temperature 35° C.) to prepare shoe sole preforms for further foaming. Injection pressure and holding pressure were 400 bar and 600 bar, respectively.

### Comparative Example C2

15 kg of Vestamid® E40-S3 (PEBA) and 5 kg of Elastollan® 1180A (TPU) were mixed using a Coperion ZSK—26 cm co-rotating twin screw extruder, discharged, pelletized to obtain compounded PEBA-TPU pellets. The temperature was set to 220° C. and a screw rotation speed was set to 250 rounds per minute (RPM). The compounding was conducted with a throughput of 20 kg/h.

The compounded PEBA-TPU compositions in pellet form were processed on an injection molding machine Engel VC 650/200 (melt temperature 220° C., mold temperature 35° C.) to prepare shoe sole preforms for further foaming. Injection pressure and holding pressure were 400 bar and 600 bar, respectively.

### Comparative Examples C3 and C4

3 kg of Vestamid® E55-S3 (PEBA) and 17 kg of TPU were mixed using a Coperion ZSK—26 cm co-rotating twin screw extruder, discharged, pelletized to obtain compounded PEBA-TPU pellets. The temperature was set to 220° C. and a screw rotation speed was set to 250 rounds per minute (RPM). The compounding was conducted with a throughput of 20 kg/h.

The compounded PEBA-TPU compositions in pellet form were processed on an injection molding machine Engel VC 650/200 (melt temperature 220° C., mold temperature 35° C.) to prepare shoe sole preforms for further foaming. Injection pressure and holding pressure were 400 bar and 600 bar, respectively.

The mechanical test results of compounded PEBA-TPU pellet and dry-blended PEBA-TPU pellet are shown in Table 1.

TABLE 1
Test results of compounded and dry-blended PEBA-TPU pellets

| Property | Unit | I1 | I2 | I3 | C1 | C2 | C3 | C4 |
|---|---|---|---|---|---|---|---|---|
| Density | g/cm³ | 1.024 | 1.035 | 1.041 | 1.023 | 1.035 | 1.129 | 1.184 |
| Hardness shore D | | 38.5 | 52 | 53 | 38 | 34 | 51 | 50 |
| Tensile modulus | MPa | 66.5 | 166 | 180 | 64.4 | | 62 | 121 |
| Tensile strength | MPa | 26 | 41 | 39 | 29.5 | | 51 | 46 |
| Charpy notched | kJ/m² | No | No | No | No | no | no | no |
| impact, 23° C. | | break | break | break | break | break | break | break |

The preforms made from inventive examples and comparative examples were then soaked in supercritical CO2 within an autoclave. The temperature inside the autoclave was set to be 140° C. The pressure inside the autoclave was set to be 300 bar at the initial phase. The preforms were impregnated by CO2 molecules and as a result their weight became larger. The autoclave and its enclosures then underwent a cooling and depressurization lasting several hours. The temperature finally dropped to the room temperature (20° C.) while the pressure dropped to ambient pressure (about 1 bar). The shoe sole specimens had their volume expanded multiple times.

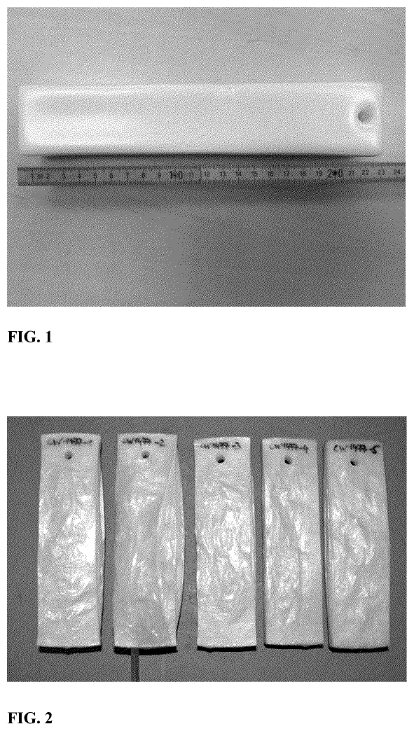

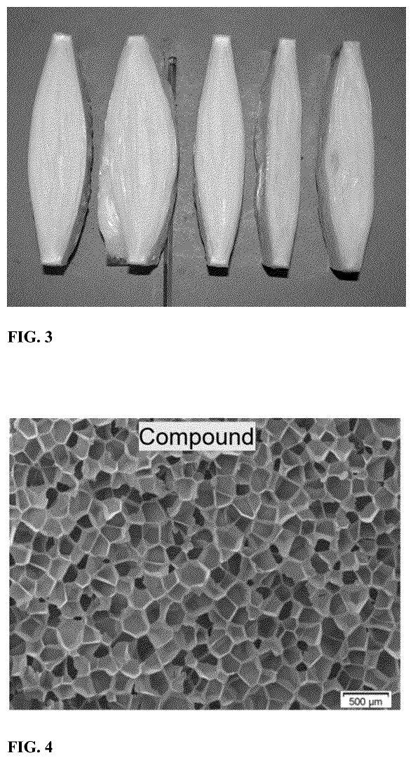

From the compounded PEBA-TPU composition, seven foamed shoe soles (I1F to I3F and C1F to C4F) were prepared after the super critical foaming process described above. The foamed shoe sole I1F to I3F showed a uniformly expanded shape, retaining the original appearance approximately, as shown in FIG. 1 for I1F. The surface of the foamed specimens was smooth and clean, without visually recognizable cracks. From the dry-blended composition, no foamed shoe soles were prepared satisfactorily, partly due to inhomogeneous dispersion of polymeric components. In contrast to those prepared by compounding, the specimens prepared from dry-blended composition expanded differentially along different dimensions after the foaming process, as shown in FIGS. 2 and 3 for C1F, making controlling of the shape difficult. The foamed parts expanded significantly more in the central part and less in the ends. In one direction, there are obvious bulge in the central part of the specimens. Even on one surface of the specimen, there were considerably wrinkle-shaped textures, accompanied with distributed yellowing. The inhomogeneous expansion and rugged surface made the dry-blended composition unsuitable for practical usage in areas requiring high surface quality and good shape control. The inhomogeneity might be results of uneven dispersion of polymeric components within the blend before the foaming process.

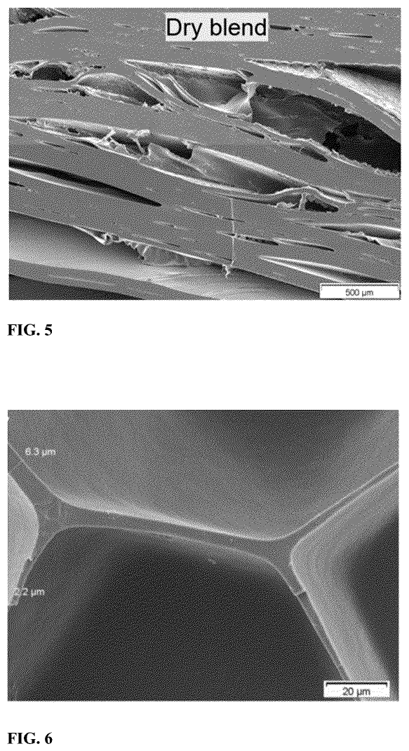

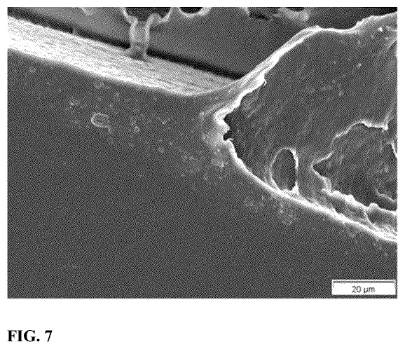

Through scanning electron microscopy (SEM), it was revealed that inside the specimens many microcells formed after foaming, as indicated in FIGS. 4 through 7. For the specimen I1F made from compounded PEBA-TPU composition, the microcells were roughly similar in shape and diameter. No separation of PEBA phase and TPU phase was revealed under 500 μm resolution and 20 μm resolution, as shown in FIG. 4 and FIG. 6, respectively. For specimen C1F made from dry blended PEBA-TPU composition, under 500 μm and 20 μm resolution, layer-layer separation was observed, as shown in FIG. 5 and FIG. 7, respectively. Small gaps with varying dimensions populated between microlayers. As dry blending usually leads to poor mixing of polymeric components, there would be multitude of voids or spaces differing in volumes between PEBA molecular chains and TPU molecular chains. When soaked in supercritical gas, the gas molecules would enter these voids or spaces inside the specimens. Thus, gaps with varying dimensions were formed in the end. The SEM images of microcellular structures clearly shown incompatibility between PEBA phase and TPU phase for specimen made from dry blended composition.

The mechanical test results of foams made from compounded PEBA-TPU composition are shown in Table 2.

TABLE 2
Test results of foams made from compounded PEBA-TPU compositions

| Property | Unit | I1F | I2F | I3F | C1F | C2F | C3F | C4F |
|---|---|---|---|---|---|---|---|---|
| Density | g/cm³ | 0.08 | 0.103 | 0.104 | 0.1 | 0.124 | 0.226 | 0.237 |
| Compression set | % | 33 | 33 | 32 | 30 | 27 | 8 | 9 |
| Ball resilience | % | 72 | 71 | 71 | 68 | 66 | 65 | 64 |
| Hardness Asker C | | 35 | 53 | 55 | 47 | 42 | 49 | 48 |

The foams prepared from inventive compounded compositions I1F to I3F can achieve a low density of below 0.12 g/cm3 while simultaneously maintaining a high ball resilience of above 70% and a compression set of more than 30%. In contrast, compounded compositions C2F to C4F have a density above 0.12 g/cm3 and a ball resilience below 70%. As a consequence, to fulfill the object of the invention, the thermoplastic polyurethane has a weight percentage of less than 22 w. % in the blend.

Various aspects and embodiments are possible. Some of those aspects and embodiments are described herein. After reading this specification, skilled artisans will appreciate that those aspects and embodiments are only illustrative and do not limit the scope of the present disclosure.

1. A foamed article prepared by a process comprising:
providing a polyether block amide and a thermoplastic polyurethane;
compounding the polyether block amide and the thermoplastic polyurethane and forming a blend;
shaping the blend and forming a preform; and
foaming the preform and obtaining the foamed article,
wherein the thermoplastic polyurethane has a weight percentage of less than 22 wt. % in the blend.

2. The foamed article according to claim 1, wherein the foamed article has a microcellular structure with an average diameter of 40 μm to 400 μm.

3. The foamed article according to claim 2, wherein the microcellular structure has a wall with a thickness of 1 μm to 20 μm.

4. The foamed article according to claim 1, wherein the foamed article has a density lower than 0.12 g/cm³.

5. The foamed article according to claim 1, wherein the blend is essentially free of compatibilizers or compounding aids.

6. The foamed article according to claim 1, wherein the foamed article is selected from the group consisting of articles of clothing, footwear, protective equipment, straps, and components thereof.

7. The foamed article according to claim 6, wherein the foamed article is a shoe sole.

8. A method for preparing the foamed article in accordance with claim 1, comprising:
providing a polyether block amide and a thermoplastic polyurethane;
compounding the polyether block amide and the thermoplastic polyurethane and forming a blend;
shaping the blend and forming a preform;
foaming the preform; and
obtaining the foamed article, wherein
the thermoplastic polyurethane has a weight percentage of less than 22 wt. % in the blend.

9. The method according to claim 8, wherein compounding the polyether block amide and the thermoplastic polyurethane is conducted by using a twin-screw extruder.

10. The method according to claim 8, wherein foaming the preform comprises soaking the preform in a supercritical gas.

71. The method according to claim 10, wherein the supercritical gas is one or more selected from the group consisting of supercritical nitrogen, supercritical carbon dioxide, and a mixture thereof.

12. The method according to claim 8, wherein foaming the preform is conducted under a temperature lower than a melting temperature of the blend.

13. The method according to claim 8, wherein foaming the preform is conducted under a temperature of 20° C. to 300° C.

14. The method according to claim 8, wherein foaming the preform is conducted under a pressure of 20 bar to 500 bar.

15. The method according to claim 8, wherein foaming the blend is carried out in an autoclave.

16. The foamed article according to claim 1, wherein the thermoplastic polyurethane has a weight percentage of less than 18 wt. % in the blend.

17. The foamed article according to claim 4, wherein the foamed article has a density lower than 0.09 g/cm³.

18. The method according to claim 8, wherein the thermoplastic polyurethane has a weight percentage of less than 18 wt. % in the blend.

19. The method according to claim 13, wherein foaming the preform is conducted under a temperature of 80° C. to 200° C.

20. The method according to claim 14, wherein foaming the preform is conducted under a pressure of 100 bar to 400 bar.
